(19) United States
(12) Patent Application Publication
(10) Pub. No.: US 2026/0188910 A1
(43) Pub. Date: Jul. 2, 2026

(54) THE FIXED STRUCTURE OF THE KEY GUIDING CENTRAL MEDIUM OF DUAL BROAD-BAND ORTHOMODE TRANSDUCER

(71) Applicant: Universal Microwave Technology, Inc., Keelung (TW)

(72) Inventors: TUNG-YI WU, Keelung (TW); YU-CHENG CHEN, Taipei (TW); WUN-KAI WU, Yilan County (TW); HSUAN-WEI CHANG, Keelung (TW); RUEI-YANG SYU, Keelung (TW); ZONG-LIN HE, New Taipei (TW)

(21) Appl. No.: 19/213,785

(22) Filed: May 20, 2025

Related U.S. Application Data
(60) Provisional application No. 63/740,264, filed on Dec. 30, 2024.

(51) Int. Cl. H01Q 13/02; H01Q 5/357

(52) U.S. Cl. CPC H01Q 13/0258; H01Q 5/357

(57) ABSTRACT

A dual broad-band orthomode transducer includes a main body and a guiding structure. The main body defines a first waveguide channel for transmitting a low frequency band signal and second waveguide channel for transmitting a high frequency band signal, the top side of the main body is configured with a feed port for receiving an electromagnetic signal. The guiding structure is erected inside the main body and includes a central medium and a sleeve sheathed on the outer periphery of the central medium, the sleeve is connected to the first waveguide channel, and the central medium is connected to the second waveguide channel. The electromagnetic signal belonging to the low frequency band signal is transmitted to the first waveguide channel through the sleeve. The electromagnetic signal belonging to the high frequency band signal is transmitted to the second waveguide channel through the central medium, without requiring additional filters or multiplexers.

### CROSS REFERENCE TO RELATED APPLICATIONS

The present application claims priority to U.S. Provisional Ser. No. 63/740,264 filed on Dec. 30, 2024, the entire content of which is incorporated by reference to this application.

### BACKGROUND OF THE INVENTION

### Field Of The Invention

The present invention relates to a structure for guiding electromagnetic wave energy in an orthomode transducer, and more particularly to a key guiding central medium used for a dual broad-band orthomode transducer and a fixed structure thereof.

### Description Of The Prior Art

As the industry of Low Earth Orbit (LEO) satellites blooms, waveguide components used in single bandwidth are gradually saturated due to the high speed requirement of data transmission and the large-scale network access demand, so existing spectrum resources become insufficient.

Traditionally, spectral resources can be enhanced by waveguide assemblies with dual-band transmission capability, such waveguide assemblies need to be equipped with a dual-band orthomode transducer. However, the dual-band orthomode transducer generally requires additional filters or multiplexers to provide a bandwidth for each band, which leads to increased circuit complexity and insertion loss, indirectly affects the overall circuit performance, and increases the production cost.

### SUMMARY OF THE INVENTION

An objective of the present invention is to configure a waveguide structure, in such a way that the bandwidth of each band can be adjusted directly by a waveguide channel design without the need for additional filters or multiplexers, in addition to achieving dual-band or multi-band transmissions.

The present invention adopts the configuration of a guiding structure to achieve an orthomode transducer with a dual broad-band transmission capability, which can divide the received electromagnetic wave into two frequency bands, while providing the effects of broad-band and high isolation.

Another objective of the present invention is to effectively simplify an originally complex structure and realize a compact design. By means of the relevant structure and arrangement according to an embodiment of the present invention, the fixing of the central medium can be achieved, thereby simplifying the originally complex structure.

The present invention is based on the design of a simplified guiding structure with the advantages of convenient manufacturing and low cost and the effect of overcoming the issues of a large number of components and a complex structure of the traditional dual-band orthomode transducers, so the present invention is more suitable for aerospace and satellite products.

The present invention based on the design of the guiding structure can realize a flat structure, thereby effectively reducing the level of difficulty of manufacturing and assembly, and significantly improving the efficiency and practicality.

According to some embodiments of the present invention, a dual broad-band orthomode transducer includes: a main body and a guiding structure. The main body includes a first waveguide channel for transmitting a low frequency band signal and a second waveguide channel for transmitting a high frequency band signal, and a feed port for receiving an electromagnetic signal is arranged on the top side of the main body. The guiding structure is erected inside the main body, and the guiding structure includes: a central medium and a sleeve sheathed on the outer periphery of the central medium, the sleeve is connected to the first waveguide channel, and the central medium is connected to the second waveguide channel. Wherein, the electromagnetic signal belonging to the low frequency band signal is transmitted to the first waveguide channel through the central medium. The electromagnetic signal belonging to the high frequency band signal is transmitted to the central medium through the second waveguide channel.

According to some embodiments of the present invention, he central medium and the sleeve are made of different materials, and the sleeve is made of a metallic material.

According to some embodiments of the present invention, the sleeve defines a through hole for coaxially arranging the central medium and the sleeve.

According to some embodiments of the present invention, an upper end of the central medium is configured with a retaining ring for abutting against an upper end surface of the sleeve, a lower end of the central medium is configured with a first thread structure for matching a second thread structure of the inner wall of the sleeve, the central medium is mounted to the sleeve by means of the retaining ring and the first thread structure, an upper end and a lower end of the central medium respectively protrude from the sleeve, and the lower end is connected to the second waveguide channel.

According to some embodiments of the present invention, the lower part of the retaining ring of the central medium is configured with a flange surrounding around the central medium, and the inner wall of the sleeve is configured with a recess matching with the flange.

According to some embodiments of the present invention, the structures of the upper end and the lower end of the central medium are tapered upward in an extending direction.

According to some embodiments of the present invention, the structures of the upper end and the lower end of the central medium are in a stepped tapering structure or a pointed conical shape, and the central medium is in a substantially cylindrical shape.

According to some embodiments of the present invention, the outer wall of the central medium and the inner wall of the through hole of the sleeve are not tightly sealed.

According to some embodiments of the present invention, the sleeve sequentially comprises a front section, a middle section and a rear section arranged in a downward direction from the feed port, the outer diameter of the rear section is greater than the outer diameter of the front section, the shape of the middle section gradually tapers from the position where it connects to the rear section and couples to the front section, and the middle section is connected to the first waveguide channel.

According to some embodiments of the present invention, the middle section is in a frustum shape, the middle section is an inclined structure based on an angle of inclination substantially ranging from 50 degrees to 60 degrees, the outer diameter of the front section substantially ranging from 3 mm to 4 mm, and the outer diameter of the rear section substantially ranging from 7 mm to 8 mm. In some embodiments, the angle of inclination is equal to 55 degrees, the outer diameter of the front section is equal to 3.4 mm, and the outer diameter of the rear section is equal to 7.4 mm.

According to some embodiments of the present invention, the front section near the middle section is configured with a first protruding ring and a second protruding ring surrounding around the sleeve, the outer diameter the first protruding ring is greater than the second protruding ring and closer to the middle section compared to the second protruding ring, and the thickness of the first protruding ring is thinner than the thickness of the second protruding ring.

According to some embodiments of the present invention, the main body is formed by a plurality of plates, the main body defines an upper cavity communicating the first waveguide channel with the feed port, and a lower cavity communicating the second waveguide channel with the upper cavity, the guiding structure is configured in the main body through the upper cavity and the lower cavity, and the sleeve is fixed to one of the plates by a seat configured at the periphery of the rear section.

According to some embodiments of the present invention, the upper cavity has a cavity wall with an inner diameter greater than the outer diameter of the front section of the sleeve, such that a space is defined between the front section and the cavity wall of the upper cavity.

According to some embodiments of the present invention, the low frequency band includes at least one of the two frequency bands selected from 18 GHz and 30 GHz.

According to some embodiments of the present invention, the central medium is made of a polymer material or a plastic material.

### BRIEF DESCRIPTION OF THE DRAWINGS

FIG. 1 is a schematic view showing the disassembled parts of a dual broad-band orthomode transducer in accordance with an embodiment of the present invention.

FIG. 2 is an isomeric view of a waveguide channel of a dual broad-band orthomode transducer in accordance with an embodiment of the present invention.

FIG. 3 is another isomeric view of a waveguide channel of a dual broad-band orthomode transducer as depicted in FIG. 1.

FIG. 4 is a schematic view showing the disassembled parts of a guiding structure in accordance with an embodiment of the present invention.

FIG. 5 is another schematic view showing the disassembled parts of the embodiment as depicted in FIG. 4.

FIG. 6 is a cross-sectional view of a guiding structure in accordance with an embodiment of the present invention.

FIG. 7 is a cross-sectional view of a dual broad-band orthomode transducer in accordance with an embodiment of the present invention.

### DESCRIPTION OF THE PREFERRED EMBODIMENTS

The technical characteristics, contents, advantages and effects of the present invention will become apparent from the following detailed description taken with the accompanying drawing.

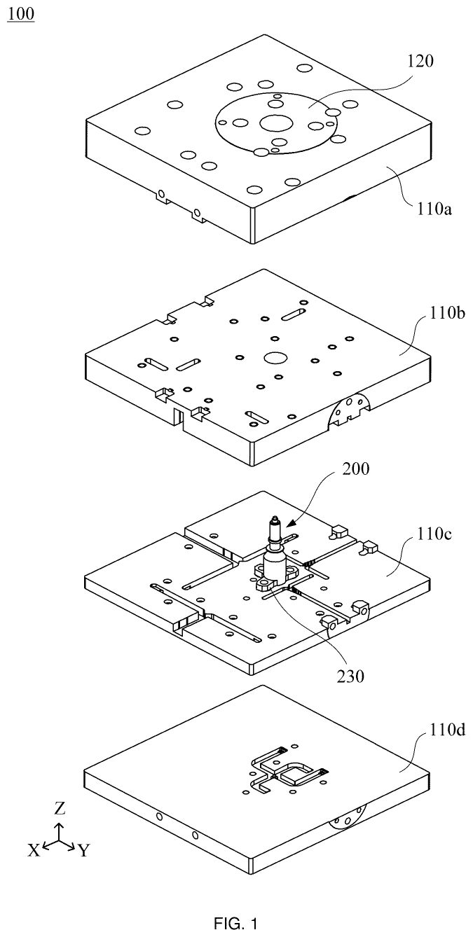

FIGS. 1 to 3 show the isomeric disassembled view of a dual broad-band orthomode transducer, and the two isomeric views of a waveguide channel of the dual broad-band orthomode transducer in accordance with an embodiment of the present invention respectively.

In FIG. 1, cavity channels are built in the dual broad-band orthomode transducer 100 by the design of combining a multiple of plates 110a˜110d, and the cavity channels form corresponding waveguide channels (or waveguide spaces). These plates 110a˜110d are combined to form a main body.

The mode transducers usually adopts a metal shell, and casts a shell wall on the shell to define the shape of the waveguide channel, so that electromagnetic signals can be transmitted in the mode transducer, separated in different polarization directions, and guided to the corresponding connected branch waveguide channel.

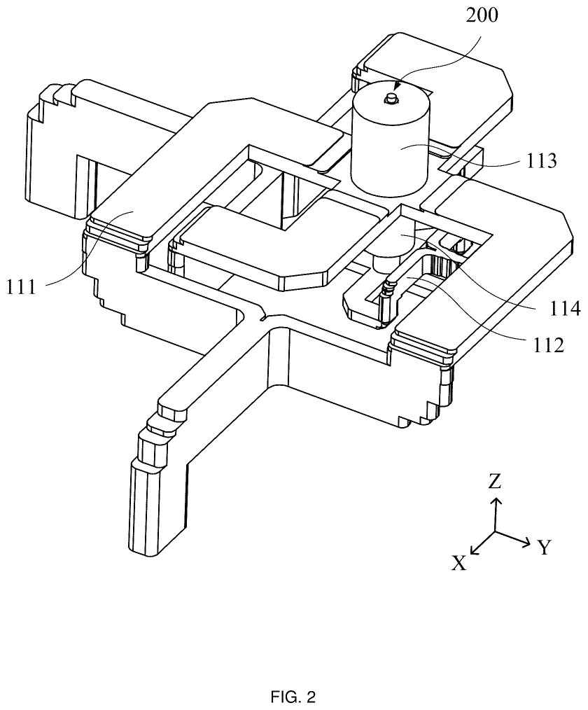

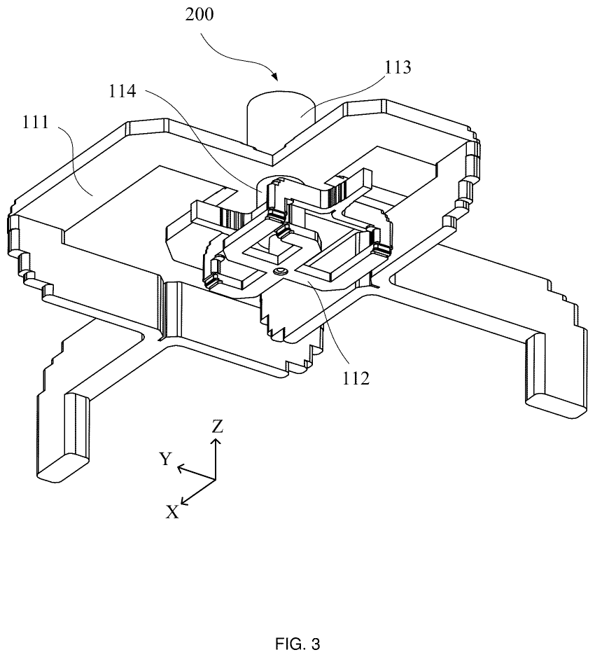

To facilitate the description of the transmission environment of the electromagnetic signal in the mode transducer, FIG. 2 and FIG. 3 present the waveguide channel in the mode transducer in a perspective view. Wherein, the waveguide channel in the mode transducer is defined by the wall structure inside the shell. As shown in FIGS. 2 and 3, the waveguide channel dual defined in the broad-band orthomode transducer 100 includes a first waveguide channel 111 and a second waveguide channel 112. The first waveguide channel 111 is used for transmitting low frequency band signals, and the second waveguide channel 112 is used for transmitting high frequency band signals with a frequency band greater than that of the first waveguide channel 111.

For example, the first waveguide channel 111 can be used for transmitting signals having a frequency band of 18 GHz or 30 GHz. Further, In the structure configuration of the embodiment of the present invention, the first waveguide channel 111 can be used for signal transmission of the frequency bands of 18 GHz and 30 GHz at the same time, which means that the second waveguide channel 112 will be suitable for higher frequency band signal transmission. With regard to the frequency band described, for example, an 18 GHz frequency band is usually referred to a frequency band centered at 18 GHz and having a frequency range (for example: hundreds of MHz to about 1 GHz) that forms the corresponding frequency band.

The electromagnetic signal is guided into a guiding structure 200 from a feed port 120 at the top side of the dual broad-band orthomode transducer 100. The guiding structure 200 is erected inside the main body, and used to receive electromagnetic signals from the feed port 120. The guiding structure 200 is connected to the first waveguide channel 111 and the second waveguide channel 112. The guiding structure 200 is used to guide the first frequency band signal in the introduced electromagnetic signal to the first waveguide channel 111, and to guide the second frequency band signal to the second waveguide channel 112, thereby achieving the effect of separating frequency bands.

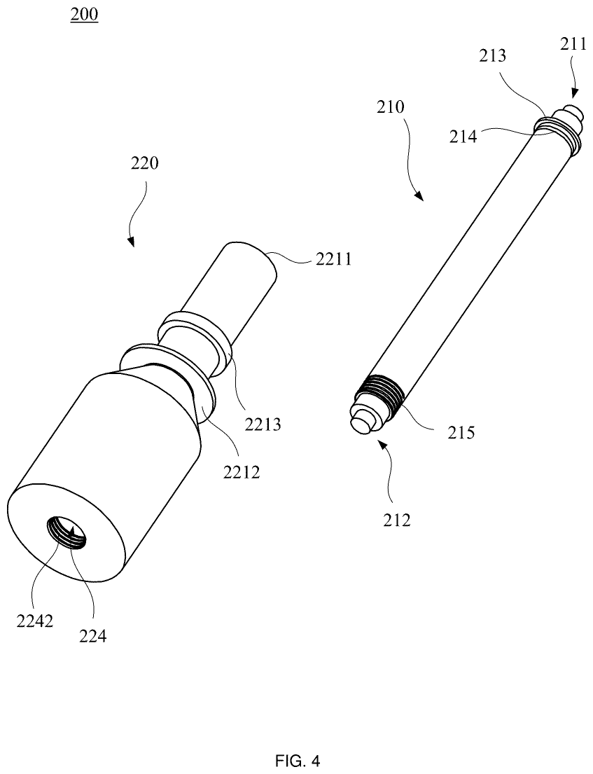

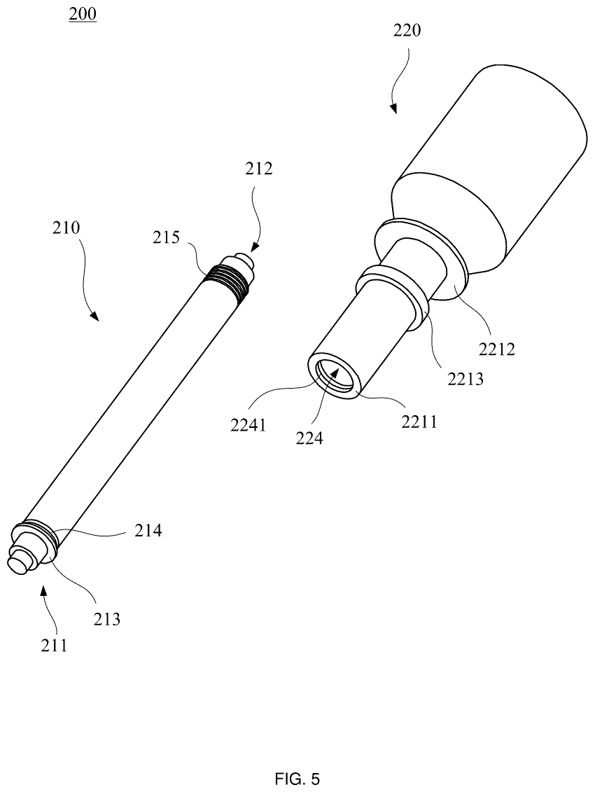

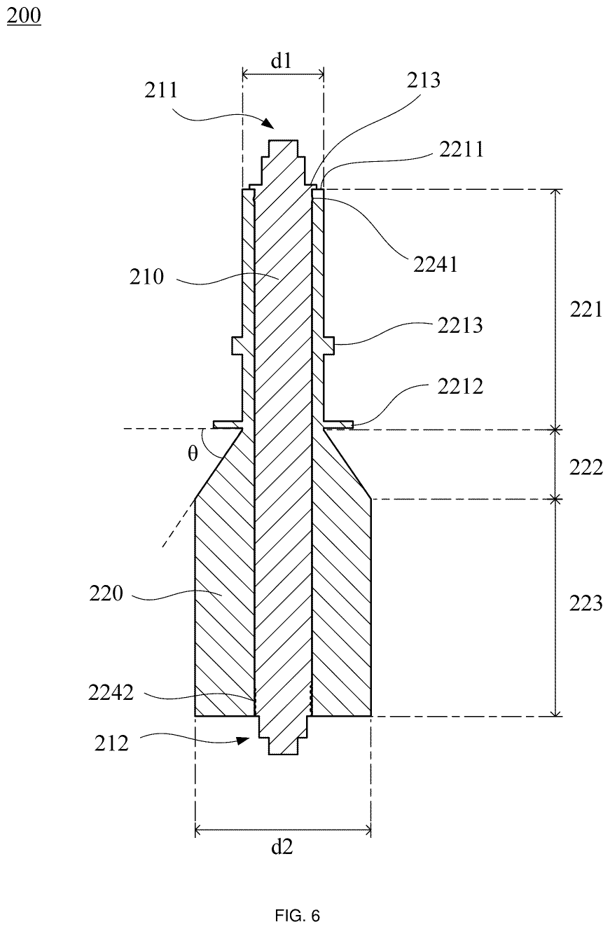

With reference to FIGS. 4 to 6 at the same time, FIG. 4 shows the disassembled parts of a guiding structure in accordance with an embodiment of the present invention, FIG. 5 is a schematic view of the embodiment as depicted in FIG. 4 showing the disassembled parts from another viewing angle, and FIG. 6 is a cross-sectional view of a guiding structure in accordance with an embodiment of the present invention.

As shown in FIGS. 4 to 6, the guiding structure 200 includes a central medium 210 and a coaxial sleeve 220 sheathed on the outer periphery of the central medium 210. The central medium 210 is in a substantially cylindrical shape. Both ends of the central medium 210 are in a pointed conical shape. In some embodiments, the upper end 211 and the lower end 212 (or the outer peripheries) of the central medium 210 are stepped tapering structures that can be formed into a pointed conical shape.

The central medium 210 and the coaxial sleeve 220 are made of different materials. For example, the coaxial sleeve 220 is made of a metallic material, and the central medium 210 is made of a non-metallic material. In some embodiments, the central medium 210 is made of a polymer material, a plastic material, etc.

In general, the through hole 224 at the middle of the coaxial sleeve 220 is a penetrating hole that can be used for transmitting high frequency band signals. Due to the demand for high frequency band, the inner diameter of the through hole 224 is often required to be as large as possible. However, the shell of the coaxial sleeve 220 is used to transmit low frequency band signals. Due to the requirements of the low frequency band, the outer diameter of the coaxial sleeve 220 needs to be as small as possible, which leads to a contradiction. In order to effectively transmit both high frequency band and low frequency band signals, the central medium 210 is plugged into the coaxial sleeve 220 in an embodiment of the present invention. The use of different materials allows the high frequency band signal to be transmitted effectively based on the central medium 210, and it is not necessary to increase the inner diameter of the through hole 224 at the middle of the coaxial sleeve 220, but just adopts an outer diameter of the coaxial sleeve 220 that is suitable for low frequency band transmissions. The dual broad-band orthomode transducer in accordance with this embodiment of the present invention can simplify the complicated configurations.

The end edge of the upper end 211 of the central medium 210 can be configured with a retaining ring 213 and a flange (ring) 214 arranged under the retaining ring 213 and surrounding around the central medium 210. The central medium 210 near the outer surface of the lower end 212 can be configured with a first thread structure 215. For example, the first thread structure 215 is an externally threaded structure.

The coaxial sleeve 220 has a through hole 224 formed at the center for the central medium 210 and provided to be installed therein, so that the central medium 210 and the coaxial sleeve 220 are coaxially configured. The coaxial sleeve 220 can be divided into a front section 221, a middle section 222 and a rear section 223. The front section 221 is a pipe with a first outer diameter, the rear section 223 is a pipe with a diameter greater than the first outer diameter, and the middle section 222 is in a frustum shape. The middle section 222 is used for connection and transition of the difference in tube diameter between the front section 221 and the rear section 223.

For example, the middle section 222 may be an inclined structure having an angle of inclination θ of about 50 to 60 degrees. In some embodiments, the middle section 222 can be an inclined structure with an angle of inclination substantially equal to 55 degrees. In some other embodiments, the outer diameter d1 of the front section 221 is 3˜4 mm, and the outer diameter d2 of the rear section 223 is 7˜8 mm. In some further embodiments, the outer diameter of the front section 221 is substantially equal to 3.4 mm, and the outer diameter of the rear section 223 is substantially equal to 7.4 mm.

In some embodiments, the middle section 222 is in a shape tapering in a direction towards the front section 221, and the tapering can be formed with a stepped structure.

When the central medium 210 is installed in the through hole 224 of the coaxial sleeve 220 and on the front section 221, the end surface 2211 of the coaxial sleeve 220 can be used to achieve the effect of abutting against the retaining ring 213. The inner wall of the through hole 224 may be provided with a recess 2241 matching the flange (ring) 214 of the central medium 210 at the position of the front section 221 to further provide a stable installation of the central medium 210. On the other hand, the inner wall of the through hole 224 may be provided with a second thread structure 2242 matching the first thread structure 215 at a position adjacent to the bottom edge of the rear section 223.

The end surface 2211, recess 2241 and second thread structure 2242 of the coaxial sleeve 220 can be used together to provide a stable installation of the central medium 210. For example, it can be an internally threaded structure, and the screw-in structure constructed by the first thread structure 215 and the second thread structure 2242 is easy to manufacture and assemble, and it can avoid damage to the dual broad-band orthomode transducer 100 that may be caused by the implantation and compression processes. It is noteworthy that the outer surface of the central medium 210 and the inner wall of the through hole 224 of the coaxial sleeve 220 are not tightly sealed, but there is a slight gap or the outer diameter of the central medium 210 is slightly smaller than the inner diameter of the through hole 224. This helps to smoothly assemble the central medium 210 into the through hole 224 and improve the transmission efficiency when the second frequency band signal is guided to the second waveguide channel 112.

The coaxial sleeve 220 may be provided with a first protruding ring 2212 and a second protruding ring 2213 in an area near the middle section 222 of the front section 221. The first protruding ring 2212 is closer to the middle section 222 than the second protruding ring 2213. In appearance, the first protruding ring 2212 has an outer diameter greater than that of the second protruding ring 2213, but has a thickness thinner than that of the second protruding ring 2213. In terms of the angle of the outer diameter and the direction towards the end surface 2211, the configuration of the first protruding ring 2212 and the second protruding ring 2213 presents the configuration of a tapered structure.

Under such structural configuration, after the electromagnetic signal is guided, the first frequency band signal belonging to the low frequency band can be guided from the middle section 222 through the wall (thickness) of the coaxial sleeve 220, so that the first frequency band signal can enter into the first waveguide channel 111. Through the central medium 210 in the coaxial sleeve 220, the second frequency band signal belonging to a high frequency band can be guided from the pointed conical shaped structure of the lower end 212 of the central medium 210 at the end of the rear section 223, so that the second frequency band signal can enter into the second waveguide channel 112.

With the structures of the key guiding structure of the dual broad-band orthomode transducer as described above, especially the central medium 210 made of a material different from that of the coaxial sleeve 220, both low frequency band and high frequency band signals can use the same port (e.g., feed port 120) for transmission. In addition, the two frequency bands can also be separated from each other to avoid mutual interference. Based on this, the dual broad-band orthomode transducer can easily construct the first waveguide channel 111 belonging to the low frequency band and the second waveguide channel 112 belonging to the high frequency band easily by adjusting the waveguide structure that matches the frequency band, thereby increasing the bandwidth to a level capable of satisfying most requirements.

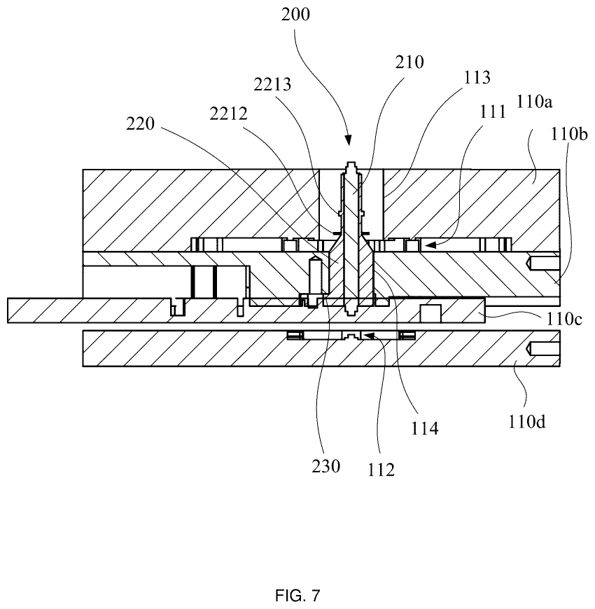

With reference to FIGS. 1, 6 and 7 at the same time, the plates 110a˜110d of the dual broad-band orthomode transducer 100 are provided with an upper cavity 113 and a lower cavity 114 at positions where the guiding structure 200 is installed. The front section 221 of the coaxial sleeve 220 of the guiding structure 200 is located in the upper cavity 113 and has a hollow space between the upper cavity 113 and the cavity wall. The rear section 223 of the coaxial sleeve 220 of the guiding structure 200 is located in the lower cavity 114 and attached to the cavity wall of the lower cavity 114. A seat 230 may be arranged around the rear section 223 of the coaxial sleeve 220 and provided for locking the guiding structure 200 onto the plate 110c. The seat 230 and the coaxial sleeve 220 may be an integrally formed structure, but the present invention is not limited thereto.

In the disclosure above, the terms “approximately”, “about”, “nearly”, “substantially” or “essentially” generally refer to “any approximate value of a given value” or “any approximate value of a given range”. These approximate values may vary depending on the relevant fields, and their range of variation should be consistent with the broadest interpretation understood by those having ordinary skill in the art to cover similar implementations and all modifications based on such variations. In some embodiments, it should generally refer to within 20% of a “given value” or “given range”, further within 10%, or and further within 5%. The numerical quantities given herein are approximate, meaning that if not expressly stated, it can be inferred that these numerical values belong to the category of “about”, “approximately”, “nearly”, “substantially” or “essentially”, or are meant to include other approximate values.

The present disclosure is illustrated by various aspects and embodiments. However, persons skilled in the art understand that the various aspects and embodiments are illustrative rather than restrictive of the scope of the present disclosure. After perusing this specification, persons skilled in the art may come up with other aspects and embodiments without departing from the scope of the present disclosure. All equivalent variations and replacements of the aspects and the embodiments must fall within the scope of the present disclosure. Therefore, the scope of the protection of rights of the present disclosure shall be defined by the appended claims.

What is claimed is:

1. A dual broad-band orthomode transducer, comprising:
a main body, defining a first waveguide channel for transmitting a low frequency band signal and a second waveguide channel for transmitting a high frequency band signal, and the top side of the main body being configured with a feed port for receiving an electromagnetic signal; and a guiding structure, erected inside the main body, and the guiding structure comprising: a central medium and a sleeve sheathed on the outer periphery of the central medium and coupled to the first waveguide channel, and the central medium being coupled to the second waveguide channel, wherein, the electromagnetic signal belonging to the low frequency band signal is transmitted to the first waveguide channel through the sleeve, and the electromagnetic signal belonging to the high frequency band signal is transmitted to the second waveguide channel through the central medium.

2. The dual broad-band orthomode transducer according to claim 1, wherein the central medium and the sleeve are made of different materials, and the sleeve is made of a metallic material.

3. The dual broad-band orthomode transducer according to claim 2, wherein the sleeve defines a through hole for coaxially arranging the central medium and the sleeve.

4. The dual broad-band orthomode transducer according to claim 3, wherein an upper end of the central medium is configured with a retaining ring for abutting against an upper end surface of the sleeve, a lower end of the central medium is configured with a first thread structure for matching a second thread structure of the inner wall of the sleeve, the central medium is mounted to the sleeve by means of the retaining ring and the first thread structure, an upper end and a lower end of the central medium respectively protrude from the sleeve, and the lower end is coupled to the second waveguide channel.

5. The dual broad-band orthomode transducer according to claim 4, wherein the lower part of the retaining ring of the central medium is configured with a flange surrounding around the central medium, and the inner wall of the sleeve is configured with a recess matching with the flange.

6. The dual broad-band orthomode transducer according to claim 4, wherein the structures of the upper end and the lower end of the central medium are tapered upward in an extending direction.

7. The dual broad-band orthomode transducer according to claim 6, wherein the structures of the upper end and the lower end of the central medium are in a stepped tapering structure or a pointed conical shape, and the central medium is in a substantially cylindrical shape.

8. The dual broad-band orthomode transducer according to claim 7, wherein the outer wall of the central medium and the inner wall of the through hole of the sleeve are not tightly sealed.

9. The dual broad-band orthomode transducer according to claim 4, wherein the sleeve sequentially comprises a front section, a middle section and a rear section arranged in a downward direction from the feed port, the outer diameter of the rear section is greater than the outer diameter of the front section, the shape of the middle section gradually tapers from the position where it connects to the rear section and couples to the front section, and the middle section is coupled to the first waveguide channel.

10. The dual broad-band orthomode transducer according to claim 9, wherein the middle section is in a frustum shape, the middle section is an inclined structure based on an angle of inclination substantially ranging from 50 degrees to 60 degrees, the outer diameter of the front section substantially ranging from 3 mm to 4 mm, and the outer diameter of the rear section substantially ranging from 7 mm to 8 mm.

11. The dual broad-band orthomode transducer according to claim 10, wherein the angle of inclination substantially equals to 55 degrees, the outer diameter of the front section substantially equals to 3.4 mm, and the outer diameter of the rear section substantially equals to 7.4 mm.

12. The dual broad-band orthomode transducer according to claim 9, wherein the front section near the middle section is configured with a first protruding ring and a second protruding ring surrounding around the sleeve, the outer diameter the first protruding ring is greater than the second protruding ring and closer to the middle section compared to the second protruding ring, and the thickness of the first protruding ring is thinner than the thickness of the second protruding ring.

13. The dual broad-band orthomode transducer according to claim 9, wherein the main body is formed by a plurality of plates, the main body defines an upper cavity communicating the first waveguide channel with the feed port, and a lower cavity communicating the second waveguide channel with the upper cavity, the guiding structure is configured in the main body through the upper cavity and the lower cavity, and the sleeve is fixed to one of the plates by a seat configured at the periphery of the rear section.

14. The dual broad-band orthomode transducer according to claim 13, wherein the upper cavity has a cavity wall with an inner diameter greater than the outer diameter of the front section of the sleeve, such that a space is defined between the front section and the cavity wall of the upper cavity.

15. The dual broad-band orthomode transducer according to claim 9, wherein the low frequency band includes at least one of the two frequency bands selected from 18 GHz and 30 GHz.

16. The dual broad-band orthomode transducer according to claim 9, wherein the central medium is made of a polymer material or a plastic material.
